(19) United States
(12) Patent Application Publication
(10) Pub. No.: US 2013/0126714 A1
(43) Pub. Date: May 23, 2013

(54) LIGHT ENERGY TESTING DEVICE

(71) Applicants: YU-SHU CHEN, Chu-Nan (TW); KUO-FENG CHIANG, Chu-Nan (TW); YING-CHING CHEN, Chu-Nan (TW); ZHENG-JAY HUANG, Chu-Nan (TW); KUO-MANG LO, Chu-Nan (TW); CHIEN-TING LU, Chu-Nan (TW)

(72) Inventors: YU-SHU CHEN, Chu-Nan (TW); KUO-FENG CHIANG, Chu-Nan (TW); YING-CHING CHEN, Chu-Nan (TW); ZHENG-JAY HUANG, Chu-Nan (TW); KUO-MANG LO, Chu-Nan (TW); CHIEN-TING LU, Chu-Nan (TW)

(73) Assignee: FOXSEMICON INTEGRATED TECHNOLOGY, INC., Chu-Nan (TW)

(21) Appl. No.: 13/300,666

(22) Filed: Nov. 21, 2011

(51) Int. Cl. G01J 1/42

(52) U.S. Cl. 250/208.6

(57) ABSTRACT

A light energy testing device includes a light source emitting parallel light, a Fresnel lens concentrating the parallel light, a fiber array consisting of a plurality of optical fibers, and an energy detecting device. Each fiber includes a light incident and emitting surface. The light incident surfaces are coplanar to define a light receiving surface. The light emitting surfaces cooperatively define a light transmitting surface. The energy detecting device includes a plurality of sensor units optically coupled with the light transmitting surface and a testing device connected to the sensor units. The parallel light is focused by the Fresnel lens to irradiate the light receiving surface. The sensor units generate energy signals according to the light from the light transmitting surface. The energy detecting device calculates a light energy distribution according to the energy signals.

### BACKGROUND

1. Technical Field

The present disclosure relates to a light energy testing device, and more particularly, to a light energy testing device including a fiber array for testing light energy.

2. Description of Related Art

Solar power devices in the way of focusing the energy density of sunlight to irradiate the solar cells, such as silicon chips, to obtain larger current in a smaller area of the solar cell unit, thereby improving the photoelectric conversion efficiency of solar cells are widely used. However, there are few testing devices can accurately calculate the energy distribution of the sunlight focused on the smaller solar cell unit.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic, isometric view of a light energy testing device in accordance with one embodiment.

FIG. 2 is a energy distribution diagram obtained by the light energy testing device of FIG. 1.

FIG. 3 is an other energy distribution diagram obtained by the light energy testing device of FIG. 1.

### DETAILED DESCRIPTION

Reference will now be made to the drawings to describe various inventive embodiments of the present disclosure in detail, wherein like numerals refer to like units throughout.

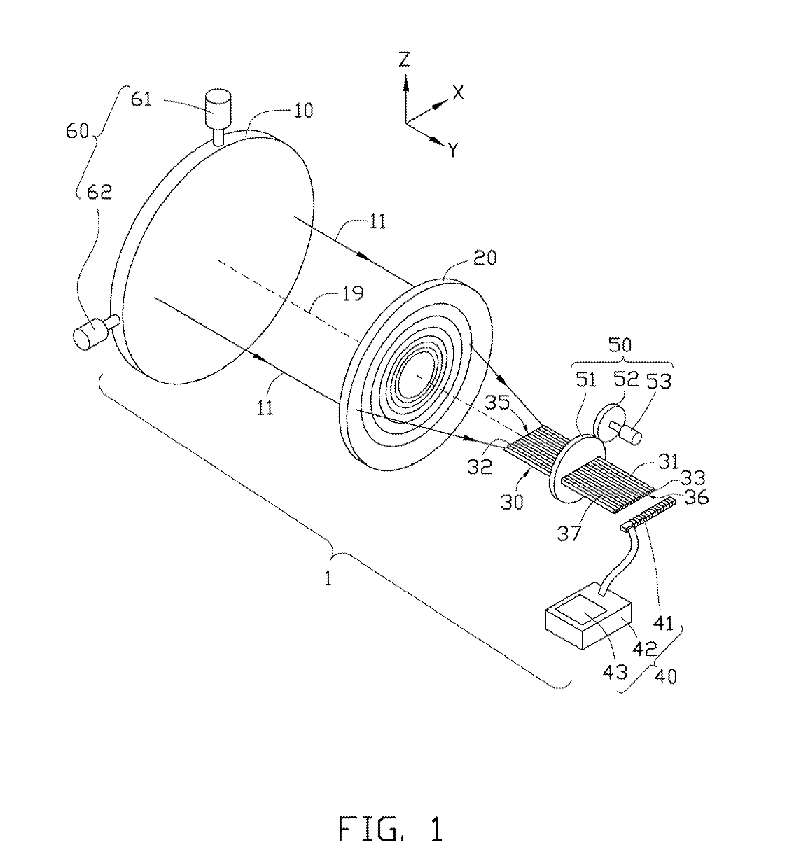

Referring to FIG. 1, a light energy testing device 1 according to one embodiment of the present disclosure includes a light source 10, a Fresnel lens 20, a fiber array 30, an energy detecting device 40, a rotating device 50, and an angle regulator 60. The Fresnel lens 20 is arranged between the light source 10 and the fiber array 30 and aligned with each other along an optical axis 19 through centers of the light source 10, the Fresnel lens 20 and the fiber array 30.

The fiber array 30 includes a plurality of column fiber 31 adjacent to each other. Each fiber 31 is an optical fiber and includes a light incident surface 32 at an end, a light emitting surface 33 at an opposite end, and a side surface sandwiched between the light incident surface 32 and the light emitting surface 33. All the light incident surfaces 32 of the fibers 31 are coplanar to define a light receiving surface 35 at a focal spot of the Fresnel lens 20. All the light emitting surfaces 33 of the fibers 31 are coplanar to define a light transmitting surface 36. In this embodiment, the light receiving surface 35 and the light transmitting surface 36 are elongated rectangle surfaces perpendicular to the optical axis 19. Each of the light receiving surface 35 and the light transmitting surface 36 is symmetrically arranged at opposite sides of optical axis 19.

In one embodiment, the fibers 31 are parallel to each other and arranged in a planar surface. Each fiber 31 extends along a direction parallel to the optical axis 19. A reflecting film (not labeled) is provided to coat the side surface to improve a light transmission efficiency of each fiber 31. In alternative embodiments, a cross-sectional view of each fiber 31 can be of circle, triangle or square.

The energy detecting device 40 includes a plurality of sensor units 41 and a calculating device 42 connected to each sensor unit 41. The calculating device 42 includes a display 43. The plurality of sensor units 41 are optically coupled with the light transmitting surface 36. In this embodiment, each sensor unit 41 is aligned to one corresponding light emitting surface 33. The light 11 emitted from the light source 10 is focused by the Fresnel lens 20 to irradiate at least a part of the light receiving surface 35, and then emit out from the light transmitting surface 36 after passing through the fiber array 30. The sensor units 41 which are coupled with the light transmitting surface 36 generate energy signals according to the light 11 emitted out from the light transmitting surface 36 and send the energy signals to the calculating device 42. The calculating device 42 calculates a light energy distribution of the light 11 irradiating on the light receiving surface 35 according to the energy signals and displays the light energy distribution on the display 43.

The rotating device 50 includes a first gear 51 fixed with the fiber array 30, a second gear 52 engages with the first gear 51, and a motor 53 for rotating the second gear 52 together with the first gear 51. The fiber array 30 is fixed to the first gear 51 along its diameter and can be rotated to a predetermined position for testing the light energy distribution of the light 11 at the focal spot of the Fresnel lens 20 (i.e., the light receiving surface 35) corresponding to the predetermined position.

The angle regulator 60 includes a first adjustor 61 and a second adjustor 62. For ease of description, as shown in FIG. 1, a three-dimensional Cartesian coordinate system (X, Y, Z) is introduced. The optical axis 19 is parallel to the Y coordinate axis. The light 11 emitted form the light source 10 propagates along the direction of Y coordinate axis. In this embodiment, the first adjustor 61 enables a light emitting surface of the light source 10 be rotatable around the Z coordinate axis. The second adjustor 62 enables the light emitting surface of the light source 10 be rotatable around the X coordinate axis. Therefore, the light 11 emitted from the light source 10 can be adjusted to any direction slantwise to the optical axis 19. In this embodiment, an angle between the optical axis 19 and the light 11 can be adjusted to any acute angle by the first adjustor 61 and the second adjustor 62.

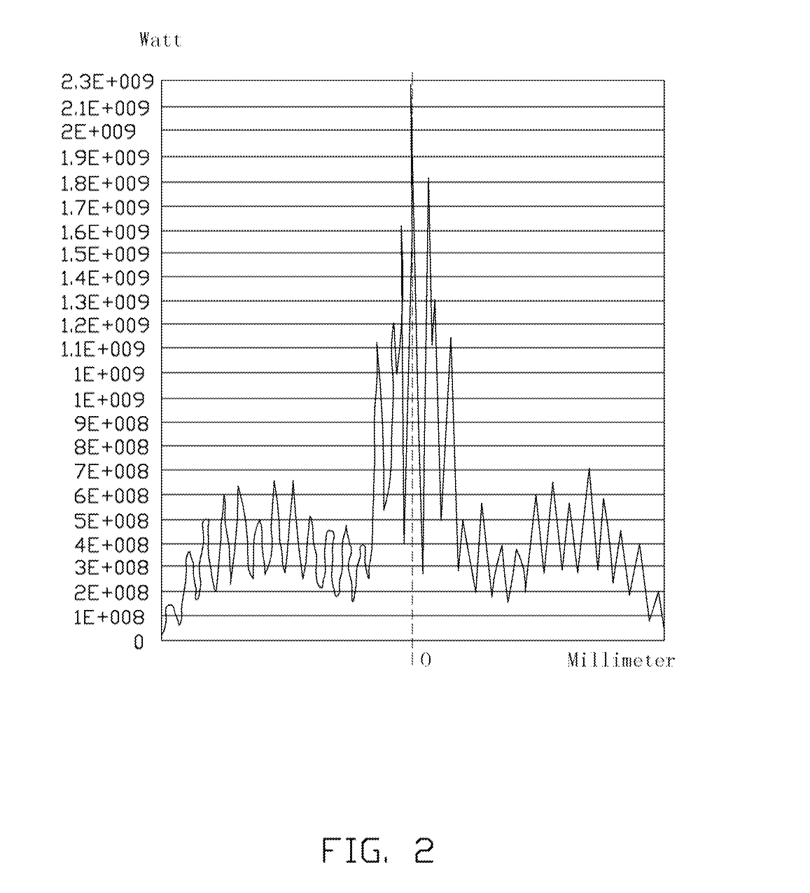

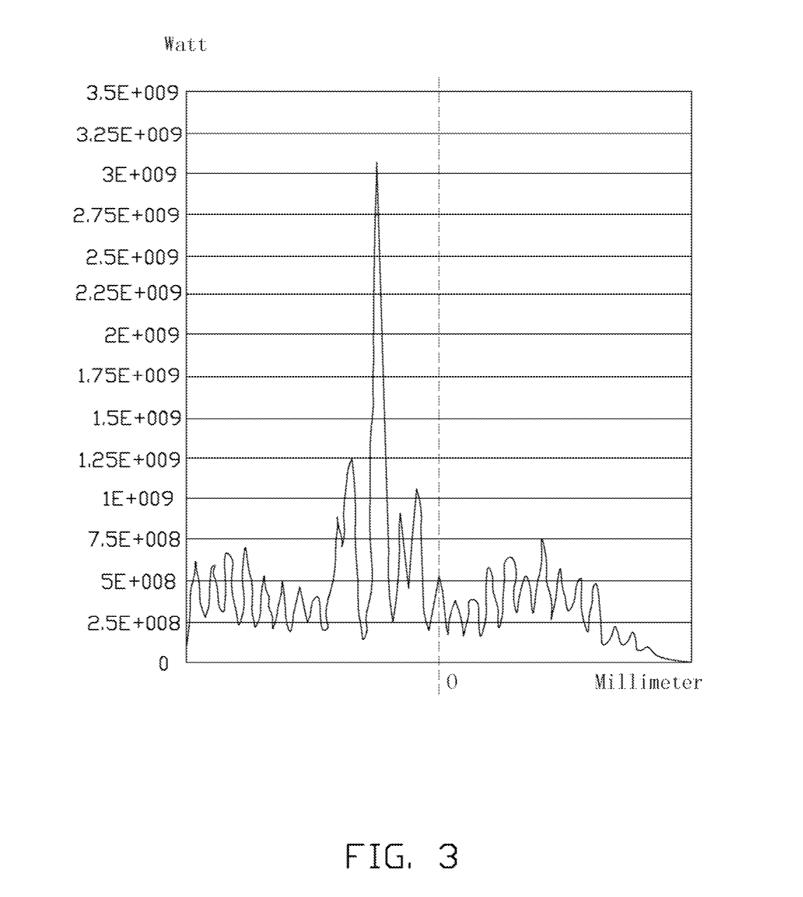

In one embodiment, the direction of the light 11 emitting form the light source 10 is substantially parallel to the optical axis 19, in other words, parallel to the Y coordinate axis, and a light energy distribution of the light 11 at the focal spot of the Fresnel lens 20 (i.e., the light receiving surface 35) is shown in FIG. 2. In one alternative embodiment, the direction of the light 11 emitting form the light source 10 is slantwise to the optical axis 19 at an acute angle, in other words, slantwise to the Y coordinate axis, and a light energy distribution of the light 11 at the focal spot of the Fresnel lens 20 (i.e., the light receiving surface 35) is shown in FIG. 3. In FIGS. 2 to 3, the values of the X coordinate axis represent locations of points on the light receiving surface 35, the values of the Y coordinate axis represent energy strength of corresponding points on the light receiving surface 35.

The light energy testing device 1 employs the fiber array 30 to sense the sunlight or parallel light similar to the sunlight after the sunlight or parallel light have been focused by the Fresnel lens, an light energy distribution of sunlight or parallel light at the focal spot of the Fresnel lens can easily be tested.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A light energy testing device comprising:
a light source emitting parallel light,
a Fresnel lens concentrating the parallel light,
a fiber array comprising a plurality of fibers adjacent to each other, each fiber comprising a light incident surface and a light emitting surface, the light incident surfaces of the plurality of fibers being coplanar to define a light receiving surface at a focal point of the Fresnel lens, the light emitting surfaces of the plurality of fibers being coplanar to define a light transmitting surface, and
an energy detecting device comprising a plurality of sensor units optically coupled with the light transmitting surface and a testing device connected to the plurality of sensor units, the parallel light being focused by the Fresnel lens to irradiate the light receiving surface, the plurality of sensor units generating energy signals according to the light emitted out from the light transmitting surface, wherein the energy detecting device calculates a light energy distribution of the parallel light irradiating to the light receiving surface according to the energy signals.

2. The light energy testing device of claim 1, wherein a cross-sectional view of each fiber is of circle, triangle or square.

3. The light energy testing device of claim 1, wherein each fiber extends along a direction parallel to an optical axis of the Fresnel lens.

4. The light energy testing device of claim 1, wherein the light receiving surface is perpendicular to the optical axis.

5. The light energy testing device of claim 1, wherein, the light receiving surface is rectangular.

6. The light energy testing device of claim 1, further comprising a rotating device to rotate the light receiving surface around the optical axis.

7. The light energy testing device of claim 1 wherein, each fiber comprising a side surface sandwiched between the light incident surface and the light emitting surface, and a reflecting film is provided to coat the side surface of each fiber.

8. The light energy testing device of claim 1 wherein the plurality of sensor units are respectively coupled with the light emitting surfaces of the fibers.

9. The light energy testing device of claim 1, further comprising an angle regulator configured for adjusting an angle between the parallel light and the optical axis.

10. The light energy testing device of claim 1, wherein the energy detecting device further comprises a display configured for displaying the light energy distribution.
